(19) United States
(12) Patent Application Publication
(10) Pub. No.: US 2004/0031733 A1
(43) Pub. Date: Feb. 19, 2004

(54) System and method making use of chemical control mechanism to generate reaction liquid containing high concentration of ozone

(75) Inventors: Kon-Tsu Kin, Hsinchu (TW); Chiou-Mei Chen, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/638,364

(22) Filed: Aug. 12, 2003

(30) Foreign Application Priority Data
Aug. 16, 2002 (TW) 91118603

(51) Int. Cl. B01D 17/12

(52) U.S. Cl. 210/120; 210/134; 210/149; 210/192; 210/194

(57) ABSTRACT

A method is devised to produce a reaction liquid, for example deionized water, containing a high concentration of ozone. The method makes use of a chemical control mechanism and a recycling mechanism to enhance the dissolution of the ozone in the reaction liquid. The chemical control mechanism includes the addition of the chemical radical scavenger to a dissolution system, and the recycling mechanism recycling a portion of the resulting ozone-containing liquid back to the dissolution system, so as to enhance the ozone dissolution to an extent that the ozone concentration reaches a saturation point attainable under thermodynamics of the dissolution system.

### FIELD OF THE INVENTION

The present invention relates generally to the generation of an ozone-containing reaction liquid, and more particularly to a system and a method of producing a deionized water containing a high concentration of ozone. The system and the method involve the application of a chemical control mechanism.

### BACKGROUND OF THE INVENTION

The ozone water is widely used in the drinking water treatment, the waste water treatment, the food processing, the sterilization of medical devices, etc. It is a well-known fact that ozone is a gas which can not be easily dissolved in water. For this reason, the ozone water, which is produced by the conventional method, contains a low concentration of ozone. The conventional method is enhanced by the physical control mechanism in the hope that the ozone dissolution is improved.

In light of the excellent purifying effect, the low pollutant discharge, and the cost-effectiveness of the ozone water, the ozone water is now widely used in the process of making the advanced electronic elements, such as integrated circuit, liquid crystal display, and the like. The issue of commercial and industrial applications of the ozone water has to do with the technology by which the ozone water is effectively produced in such a way that the ozone water contains a high concentration of ozone, and that the ozone water has a high stability.

An intensive review has been done by these inventors of the present invention on the ozone-related patents issued in a period of 1981-2001. Such patents include EP 430904A1, U.S. Pat. No. 5,205,994, EP 711731A3, U.S. Pat. No. 5,670,094, U.S. Pat. No. 5,971,368, DE 19752769A1, EP 856491A3, Taiwan Pat. Serial No. 326809, U.S. Pat. No. 6,080,531, U.S. Pat. No. 6,132,629, EP 1038993A1, EP 1076632A2, and EP 1090880A1. These patents disclose the production systems of ozone water, which are basically designed in such a way that the ozone water is produced by electrolysis, and that the ozone water production control is attained by a physical control mechanism, and that an improvement is made on the contact device of gas and liquid. In another words, these prior art systems disclosed by the afore-mentioned patents accentuate the physical control mechanism, such as pressure enhancement, reduction in operating temperature, improvement on contact area of gas and liquid, and the like. To the best of this invention's knowledge, no patent has ever disclosed an ozone water production system which is designed on the basis of a chemical control mechanism.

### SUMMARY OF THE INVENTION

The primary objective of the present invention is to provide a technique which makes use of a chemical control mechanism and a recycling mechanism to generate a reaction liquid containing a high concentration of ozone.

The present invention discloses a system making use of a chemical control mechanism to generate a reaction liquid containing a high concentration of ozone, said system comprising:

an ozone gas generating equipment comprising an ozone gas generator, wherein said ozone gas generator is adapted to be connected with an air or oxygen supply source;

an ozone dissolving equipment comprising a gas-liquid dissolution unit and a reaction temperature control unit, said gas-liquid dissolution unit being provided with a gas-liquid dissolution bath and a gas-liquid separation device; said gas-liquid dissolution bath receiving a reaction liquid and a gas mixture containing ozone gas generated by said ozone gas generator, and providing a space for the ozone gas and the reaction liquid to react with each other; said gas-liquid separation device receiving a gas and liquid mixture from said gas-liquid dissolution unit, separating said gas and liquid mixture into a gas portion containing undissolved ozone gas and an ozone-containing liquid, such that the undissolved ozone gas is sent back to said gas-liquid dissolution bath to react once again with the reaction liquid, or that the undissolved ozone gas is decomposed and discharged into atmospheric air by an ozone gas destroying device, wherein said reaction temperature control unit comprises a cooling device and a heating device for regulating reaction temperature of said gas-liquid dissolution unit;

a chemical introducing mechanism for injecting a radical scavenger to said gas-liquid dissolution bath; and

a recycling mechanism comprising an outlet pipeline for discharging said ozone-containing liquid from said gas-liquid dissolution unit to a down stream point, a recycling pipeline connecting the output pipeline to said gas-liquid dissolution bath, a discharge control valve mounted on the output pipeline, and a recycling flow adjusting valve mounted on said recycling pipeline, so that a portion of said ozone-containing liquid discharged from said gas-liquid dissolution unit is recycled to said gas-liquid dissolution bath via said recycling pipeline and said recycling flow adjusting valve, and the remaining portion of said ozone-containing liquid is discharged via said outlet pipeline and said discharge control valve, and that a recycling ratio of the portion of the ozone-containing liquid recycled and the remaining portion of the ozone-containing liquid discharged can be adjusted by controlling said recycling flow adjusting valve and said discharge control valve.

Preferably, the reaction liquid is a deionized water or ordinary water, and said ozone-containing liquid is an ozone-containing water.

The present invention also provides a method making use of a chemical control mechanism to generate a reaction liquid containing a high concentration of ozone, said method comprising the following steps of:

(a) contacting an ozone gas and a reaction liquid in a gas-liquid dissolution bath in the presence of one of the radical scavengers or a combination of two or more of the radical scavengers selected from the group consisting of carbon dioxide, carbonic acid, ammonium hydrogen carbonate, ammonium carbonate, salts of carbonate ion, H₃PO₄, salts of H₂PO₄⁻, salts of HPO₄⁻, salts of PO₄⁻, acetic acid, ammonium acetate, oxalic acid, salts of oxalate ion, acetone, t-butanol, and alkanes; and

(b) recycling a portion of an ozone-containing liquid discharged from said gas-liquid dissolution bath back to said gas-liquid dissolution unit while discharging the remaining portion of said ozone-containing liquid discharged to a down stream point as a product, wherein a recycling ratio of the portion of the ozone-containing liquid recycled and the remaining portion of the ozone-containing liquid discharged is of 0.2-3.5.

In the method of the present invention, preferably the reaction liquid is a deionized water or ordinary water, and the product is an ozone-containing water.

Preferably, the radical scavenger is added to said gas-liquid dissolution bath in a dose of 10⁻²-10⁻⁵ mole of the radical scavenger per 1000 g of the deionized water.

### BRIEF DESCRIPTION OF THE DRAWING

FIG. 1 shows a block diagram of a system embodied in the present invention for generation of a highly concentrated ozone water.

### DETAILED DESCRIPTION OF THE INVENTION

The cumulative effect of the ozone concentration of a water system is a result of a series of radical cyclic reactions. In the course of the reactions, various radicals exist to induce the decomposition of the molecular ozone, so as to undermine the cumulative effect on liquid molecular ozone concentration of the ozone water system. According to the numerical simulation results of an UV-induced and ozone-induced radicals research conducted by one of the inventors of the present invention in 1992 at SEMATECH center of Excellence for Micro-contamination/Defect Assessment and Control in the United states, the longevity of the radicals is found to be far greater than 10⁻³ second reported by the past literatures, with the longevity lasting 3-4 seconds. According to the present invention, the reaction mechanism of the ozone/water mixture system can be selectively controlled by controlling the pH value of the deionized water and by adding an appropriate radical scavenger, thereby obstructing the radical reaction mode and promoting the molecular reaction mode. With the design of the flow circulation, the concentration of the molecular ozone in the ozone/water mixture system is effectively accumulated to result in a stable output lasting a protracted period of time. As a result, a system for generating a highly concentrated ozone water is thus devised.

The chemicals suitable for use as the pH adjusting substances of the present invention are hydrochloric acid, sulfuric acid, citric acid, ammonium hydroxide, and the like. The radical scavengers of the present invention include (but not limited to) carbon dioxide, carbonic acid, ammonium hydrogen carbonate, ammonium carbonate, salts of carbonate ion, H₃PO₄, salts of H₂PO₄⁻, salts of HPO₄⁻, salts of PO₄⁻, acetic acid, ammonium acetate, oxalic acid, salts of oxalate ion, acetone, t-butanol, alkanes, and the like. The radical scavengers may be used singly or in combination.

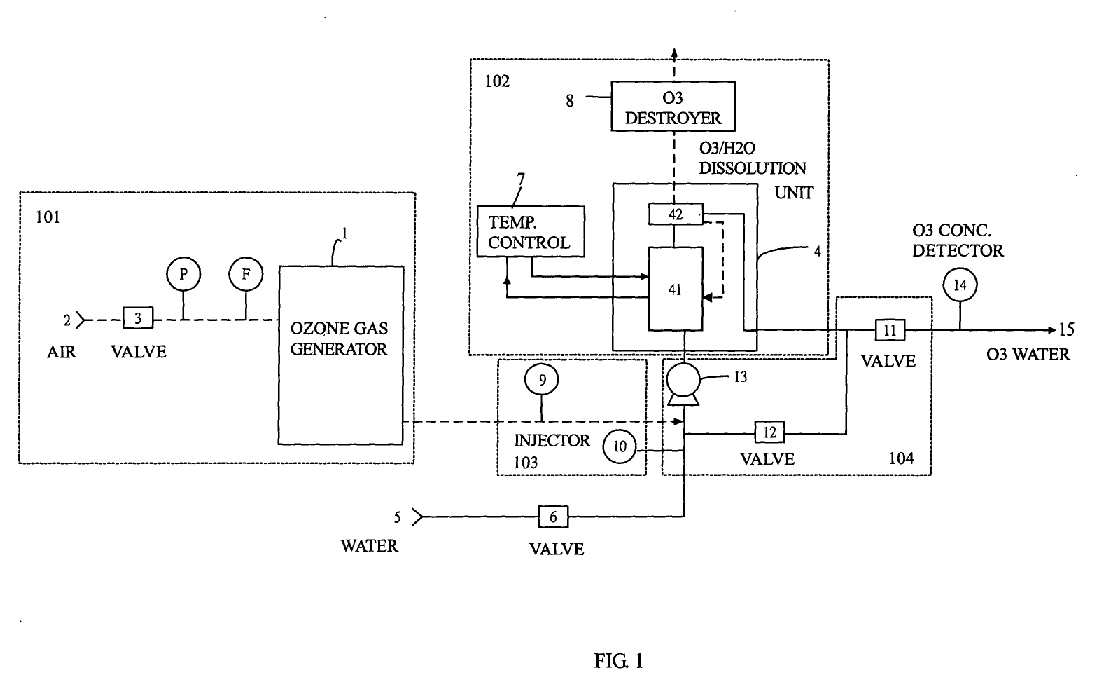

As shown in FIG. 1, a system embodied in the present invention is intended to generate a highly concentrated ozone water by making use of a chemical control mechanism. The system comprises an ozone gas generating equipment 101, an ozone dissolving equipment 102, a chemical adding mechanism 103, and a recycling mechanism 104.

The ozone gas generating equipment 101 comprises an ozone gas generator 1, a gas supply source 2 (either oxygen or air), and a gas supply adjusting valve 3 by which the amount of the ozone gas generated by the ozone gas generator 1 is controlled. The gas supply adjusting valve 3 regulates the amount of the supply gas made available by the gas supply source 2.

The ozone dissolving equipment 102 is used to effect the dissolution reaction of the ozone gas and a reaction liquid which is either a deionized water or ordinary water. The ozone dissolving equipment 102 comprises a gas-liquid dissolution unit 4, which is provided in the interior with a gas-liquid dissolution bath 41 and a gas-liquid separation device 42. The operating pressure of the gas-liquid separation device 42 is regulated by a water discharge control valve 11. A supply source 5 is used to provide the gas-liquid dissolution unit 4 with the reaction liquid, e.g. deionized water, with the flow of the reaction liquid being controlled by a flow adjusting device 6. The reaction temperature of the gas-liquid dissolution unit 4 is regulated by a temperature control device 7, which is a cooling device or heating device. The undissolved ozone gas in the gas-liquid dissolution bath 41 of the gas-liquid dissolution unit 4 is returned to the gas-liquid dissolution bath 41 via the gas-liquid separation device 42, or is sent to an ozone gas destroying device 8 for decomposing ozone gas before discharged.

The reaction liquid, e.g. deionized water, is supplied from the supply source 5 to the gas-liquid dissolution bath 41 via a deionized water supply pipeline 21 and a pump 13. A gas mixture containing ozone gas generated by the ozone gas generator 1 is supplied to the gas-liquid dissolution bath 41 via an ozone gas supply pipeline 22, the deionized water supply pipeline 21 and the pump 13.

The chemical adding mechanism 103 comprises an injector 9 mounted on the ozone gas supply pipeline 22, and/or an injecting device 10 mounted on the deionized water supply pipeline 21. A radical scavenger and, optionally, a pH adjusting substance are injected into these pipelines by the injector 9 and the injecting device 10. The injected scavenger and/or pH adjusting substance are then carried to the gas-liquid dissolution bath 41.

The recycling mechanism 104 is controlled by the water discharge control valve 11 and a recycling flow adjusting valve 12. A portion of the ozone water generated by the ozone dissolving equipment 102 is recycled to the gas-liquid dissolution bath 41 via a recycling pipeline 23, the adjusting valve 12 and the pump 13. The recycling ratio of the portion of the ozone water recycled via the adjusting valve 12 and the remaining portion of the ozone water discharged via the control valve 11 is important to the ozone concentration of the ozone water received at the output end 15. With a concentration detection point 14, an on-line detection of concentration is carried out.

An experiment was carried out by using a system similar to the one as shown in FIG. 1. The operating pressure of the gas-liquid dissolution bath 41 was 2.0 bar (gauge pressure), with the operating flow being 11 L/min. Ammonium acetate was injected by the injecting device 10 in the wake of the 21^{st} minute introduction of the deionized water into the gas-liquid dissolution bath 41, thereby resulting in the concentration of ammonium acetate of the deionized water being 0.1 mM. The on-line ozone water concentrations detected by the concentration detection point 14 are listed in the following table.

| Time (min) | Ozone water concentration (ppm) |
|---|---|
| 1 | 7.8 |
| 10 | 8.2 |
| 20 | 8.1 |
| 21 | 31.8 |
| 30 | 32.0 |
| 35 | 31.5 |
| 40 | 31.8 |
| 50 | 32.2 |

On the basis of the data listed in the above table, it is readily apparent that the concentration of the ozone contained in the ozone water generated by the gas-liquid dissolution bath 41 into which ammonium acetate was introduced was increased to 31.8 ppm from 8.1 ppm.

The embodiment of the present invention described above is to be regarded in all respects as being illustrative and nonrestrictive. Accordingly, the present invention may be embodied in other specific forms without deviating from the spirit thereof. The present invention is therefore to be limited only by the scopes of the following claims.

What is claimed is:

1. A system making use of a chemical control mechanism to generate a reaction liquid containing a high concentration of ozone, said system comprising:
an ozone gas generating equipment comprising an ozone gas generator, wherein said ozone gas generator is adapted to be connected with an air or oxygen supply source;
an ozone dissolving equipment comprising a gas-liquid dissolution unit and a reaction temperature control unit, said gas-liquid dissolution unit being provided with a gas-liquid dissolution bath and a gas-liquid separation device; said gas-liquid dissolution bath receiving a reaction liquid and a gas mixture containing ozone gas generated by said ozone gas generator, and providing a space for the ozone gas and the reaction liquid to react with each other; said gas-liquid separation device receiving a gas and liquid mixture from said gas-liquid dissolution unit, separating said gas and liquid mixture into a gas portion containing undissolved ozone gas and an ozone-containing liquid, such that the undissolved ozone gas is sent back to said gas-liquid dissolution bath to react once again with the reaction liquid, or that the undissolved ozone gas is decomposed and discharged into atmospheric air by an ozone gas destroying device, wherein said reaction temperature control unit comprises a cooling device and a heating device for regulating reaction temperature of said gas-liquid dissolution unit;
a chemical introducing mechanism for injecting a radical scavenger to said gas-liquid dissolution bath; and
a recycling mechanism comprising an outlet pipeline for discharging said ozone-containing liquid from said gas-liquid dissolution unit to a down stream point, a recycling pipeline connecting the output pipeline to said gas-liquid dissolution bath, a discharge control valve mounted on the output pipeline, and a recycling flow adjusting valve mounted on said recycling pipeline, so that a portion of said ozone-containing liquid discharged from said gas-liquid dissolution unit is recycled to said gas-liquid dissolution bath via said recycling pipeline and said recycling flow adjusting valve, and the remaining portion of said ozone-containing liquid is discharged via said outlet pipeline and said discharge control valve, and that a recycling ratio of the portion of the ozone-containing liquid recycled and the remaining portion of the ozone-containing liquid discharged can be adjusted by controlling said recycling flow adjusting valve and said discharge control valve.

2. The system as defined in claim 1, wherein the reaction liquid is a deionized water or ordinary water, and said ozone-containing liquid is an ozone-containing water.

3. A method making use of a chemical control mechanism to generate a reaction liquid containing a high concentration of ozone, said method comprising the following steps of:
(a) contacting an ozone gas and a reaction liquid in a gas-liquid dissolution bath in the presence of one of the radical scavengers or a combination of two or more of the radical scavengers selected from the group consisting of carbon dioxide, carbonic acid, ammonium hydrogen carbonate, ammonium carbonate, salts of carbonate ion, H₃PO₄, salts of H₂PO₄⁻, salts of HPO₄⁻, salts of PO₄⁻, acetic acid, ammonium acetate, oxalic acid, salts of oxalate ion, acetone, t-butanol, and alkanes; and
(b) recycling a portion of an ozone-containing liquid discharged from said gas-liquid dissolution bath back to said gas-liquid dissolution unit while discharging the remaining portion of said ozone-containing liquid discharged to a down stream point as a product, wherein a recycling ratio of the portion of the ozone-containing liquid recycled and the remaining portion of the ozone-containing liquid discharged is of 0.2-3.5.

4. The method as defined in claim 3, wherein the reaction liquid is a deionized water or ordinary water, and the product is an ozone-containing water.

5. The method as defined in claim 4, wherein the radical scavenger is added to said gas-liquid dissolution bath in a dose of 10⁻²-10⁻⁵ mole of the radical scavenger per 1000 g of the deionized water.
